(19) United States
(12) Patent Application Publication
(10) Pub. No.: US 2026/0323657 A1
(43) Pub. Date: Oct. 15, 2026

(54) MANAGING DOWNLINK CONTROL INFORMATION (DCI) CONFLICT IN WIRELESS COMMUNICATION

(71) Applicant: QUALCOMM Incorporated, San Diego, CA (US)

(72) Inventors: Varun WALIA, Hyderabad (IN); Sambit BEHURA, Hyderabad (IN); Nazmul ISLAM, Littleton, MA (US); Ansuman ADHIKARY, Hyderabad (IN); Huilin XU, Temecula, CA (US); Gaurav PUNJABI, Kolkata (IN)

(21) Appl. No.: 19/175,329

(22) Filed: Apr. 10, 2025

(51) Int. Cl. H04W 72/232; H04L 1/00

(52) U.S. Cl. CPC H04W 72/232; H04L 1/0038

(57) ABSTRACT

Aspects relate to wireless communication. A user equipment (UE) concurrently receives fallback downlink control information (DCI) on a first search space and non-fallback DCI on a second search space within a downlink control channel monitoring occasion. The first search space and the second search space are associated with a same control resource set, and the fallback DCI and the non-fallback DCI have same message sizes. The UE prioritizes one of the fallback DCI or the non-fallback DCI based on at least one criterion, and processes one of the fallback DCI or the non-fallback DCI that is prioritized. To resolve the conflict between the concurrently received fallback DCI on the first search space and the non-fallback DCI on the second search space at the UE, a network node sets a network configurable prioritization criterion, and transmits the network configurable prioritization criterion to the UE.

### BACKGROUND

### Field of the Disclosure

The present disclosure relates generally to wireless communication systems, and, more particularly, to managing downlink control information (DCI) conflict in wireless communication.

### Description of Related Art

Wireless communication systems are deployed to provide a range of communication services such as telephony, data transmission, messaging, multimedia streaming, broadcasting, or the like. The wireless communication systems can support multiple users by sharing system resources such as time, frequency, and power. For example, various multiple-access technologies, including Code Division Multiple Access (CDMA), Time Division Multiple Access (TDMA), Frequency Division Multiple Access (FDMA), Orthogonal Frequency Division Multiple Access (OFDMA), or the like, may be utilized to enable communication among multiple users. More advanced communication systems such as Long-Term Evolution (LTE) and 5G (New Radio, NR) provide enhanced capabilities for mobile broadband, massive machine-type communications (mMTC), and ultra-reliable low-latency communication (URLLC), addressing evolving demands for higher data rates, lower latency, and greater scalability.

Wireless communication (such as 5G, LTE, and the like) may utilize different search spaces within Physical Downlink Control Channel (PDCCH) to manage scheduling and control of data transmissions to user equipment (UE). These search spaces may include, for example, a Common Search Space (CSS) utilized for system-level transmissions applicable to multiple UEs and a UE-Specific Search Space (UE-SS), utilized for providing control information tailored to an individual UE. Further, these search spaces may enable transmission of Downlink Control Information (DCI), which may include control commands for various tasks such as scheduling, resource allocation, configuration updates, or the like.

Depending on operational context, DCIs may be categorized as fallback or non-fallback. Fallback DCIs may be utilized to provide signaling for maintaining link continuity and enabling recovery procedures, while non-fallback DCIs may support various functionalities such as Bandwidth Part (BWP) switching and scheduling allocation. As fallback and non-fallback DCIs are transmitted over CSS and UE-SS, there are opportunities to manage their coexistence and ensure seamless interpretation at UEs.

### SUMMARY

Aspects of the disclosure provide a user equipment (UE) for wireless communication. The UE includes one or more memories and one or more processors coupled to the one or more memories. The one or more processors individually or collectively configured to concurrently receive fallback downlink control information (DCI) on a first search space and non-fallback DCI on a second search space within a downlink control channel monitoring occasion. The first search space and the second search space are associated with a same control resource set, and the fallback DCI and the non-fallback DCI have same message sizes. The one or more processors individually or collectively further configured to prioritize one of the fallback DCI or the non-fallback DCI based on at least one criterion, and process one of the fallback DCI or the non-fallback DCI that is prioritized.

In certain aspects, a network node for wireless communication is provided. The network node includes one or more memories and one or more processors coupled to the one or more memories. The one or more processors individually or collectively configured to set a network configurable prioritization criterion that resolves a conflict between concurrently received fallback downlink control information (DCI) on a first search space and non-fallback DCI on a second search space within a downlink control channel monitoring occasion of a user equipment (UE). The first search space and the second search space are associated with a same control resource set, and the fallback DCI and the non-fallback DCI have same message sizes. The one or more processors are individually or collectively further configured to transmit to the UE the network configurable prioritization criterion.

In certain aspects of the disclosure, a method of wireless communication performed by a user equipment (UE) is provided. The method includes concurrently receiving fallback downlink control information (DCI) on a first search space and non-fallback DCI on a second search space within a downlink control channel monitoring occasion. The first search space and the second search space are associated with a same control resource set, and the fallback DCI and the non-fallback DCI have same message sizes. The method further includes prioritizing one of the fallback DCI or the non-fallback DCI based on at least one criterion, and processing one of the fallback DCI or the non-fallback DCI that is prioritized.

### BRIEF DESCRIPTION OF THE DRAWINGS

Various aspects of the present disclosure are illustrated by way of example, and not limited by the appended figures, in which like references indicate similar elements:

FIG. 1 is a diagram that illustrates an example of a wireless communication system, in accordance with certain aspects of the present disclosure;

FIG. 2 is a block diagram illustrating an example of a base station and user equipment (UE) in a wireless communication system, in accordance with certain aspects;

FIG. 3 is a block diagram illustrating an example of a resource diagram with an overlapping monitoring session for two search spaces, in accordance with certain aspects of the present disclosure;

FIG. 4 is a flowchart that illustrates a method (e.g., a process) executed at a UE for managing downlink control information (DCI) conflict in wireless communication, in accordance with an exemplary aspect of the present disclosure;

FIG. 5 is a flowchart that illustrates a method (e.g., a process) executed at a UE for managing DCI conflict in wireless communication, in accordance with an exemplary aspect of the present disclosure;

FIG. 6 is a flowchart that illustrates a method (e.g., a process) executed at a UE for managing DCI conflict in wireless communication, in accordance with an exemplary aspect of the present disclosure; and

FIG. 7 is a flowchart that illustrates a method (e.g., a process) executed at a network node for managing DCI conflict in wireless communication, in accordance with an exemplary aspect of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the disclosure will now be presented with reference to an apparatus and method. Such apparatus and method will be described in the following detailed description and illustrated in the accompanying drawings by various blocks, modules, components, circuits, steps, processes, or the like (collectively referred to as “elements”).

Accordingly, in one or more aspects, the functions described by elements of the disclosure may be implemented in hardware, software, or any combination thereof depending upon the particular application and design constraints imposed on the overall apparatus. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

At least one of a host processor, a processing core, an input/output controller, or any portion of any of such components, or any combination of such components may be implemented as a “processing system” that may include one or more processors. Examples of processors include microprocessors, microcontrollers, graphics processing units, central processing units, application processors, digital signal processors, reduced instruction set computing processors, systems on a chip, baseband processors, field programmable gate arrays, programmable logic devices, state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Fifth Generation New Radio (5G NR) networks introduce control mechanisms that enable communication between User Equipment (UE) and Next Generation Node B (gNB). These mechanisms include Downlink Control Information (DCI) scheduling, which enables a UE to receive resource allocations and system-level instructions from the gNB. However, in certain scenarios, contention between search spaces occurs when a Common Search Space (CSS) and a UE-Specific Search Space (UE-SS) overlap in time and share a same Control Resource Set (CORESET). For example, fallback DCI on CSS and non-fallback DCI on UE-SS can be received simultaneously by a UE within same PDCCH monitoring occasion. The ambiguity is exacerbated when both fallback DCI (Format 0_0/1_0) and non-fallback DCI (Format 0_1/1_1) have identical payload sizes and are transmitted over the same Control Channel Elements (CCEs) with the same scrambling identifiers. Thus, the UE may be unable to distinguish between the two simultaneously received DCIs, and may inadvertently discard the fallback DCI or misinterpret the received DCI as belonging to the incorrect search space. For example, the UE may encounter the above-described contention scenario, and incorrectly assume a Bandwidth Part (BWP) switch upon interpreting the non-fallback DCI and discard the fallback DCI, even when the fallback DCI contains system-level instructions such as paging, Random Access Response (RAR), or uplink grant assignments. This can lead to missed signaling events, potential loss of synchronization, reduced throughput, and degradation in radio resource control (RRC) stability. In other words, an absence of a defined UE behavior in such a contention scenario between CSS and UE-SS can result in ambiguity in DCI decoding and erroneous interpretation of received DCIs, which may lead to signaling failures.

Various aspects of the present disclosure provide a technical solution to prioritize a DCI format in such a contention scenario to enhance system reliability and ensure correct DCI processing by the UE. To address the above-described contention scenario, various aspects of the present disclosure involve configuring the UE with a prioritization criterion that resolves the conflict in concurrently received fallback DCI on a first search space and non-fallback DCI on a second search space. Thus, when fallback DCI on the first search space (e.g., CSS) and non-fallback DCI on the second search space (e.g., UE-SS) are received concurrently over the same CCEs, with the same scrambling IDs, and with identical payload sizes, the UE may be configured to prioritize one of the fallback DCI or the non-fallback DCI based on at least one criterion. In an example, the UE may prioritize the fallback DCI based on the at least one criterion.

In many aspects, the at least one criterion may correspond to a default prioritization criterion of the UE. The default prioritization criterion may correspond to a prioritization of first DCI having a first format (e.g., 0_0/1_0) on a CSS over a concurrently received second DCI having a second format (e.g., 0_1/1_1) on a UE-SS based on an overlap of the CSS and the UE-SS in time and frequency domains and the first DCI and the second DCI having the same scrambling identifiers and the same sizes.

In various aspects, the at least one criterion may correspond to a network configurable prioritization criterion that resolves a conflict between the fallback DCI and the non-fallback DCI that are concurrently received. For example, an Information Element (IE) may be designated in RRC signaling to provide an indication of the network configurable prioritization criterion to the UE. In other words, a network node can configure the UE with the network configurable prioritization criterion based on the RRC signaling. Thus, allowing a network node to configure which of the fallback DCI or the non-fallback DCI takes precedence in an event of a contention scenario at the UE. The network node can dynamically set the network configurable prioritization criterion based on, for example, Quality of Service (QoS) demands, traffic demands, and UE-specific constraints. Further, the network configurable prioritization criterion can be reconfigured or updated using revised RRC signaling to the UE. Thus, allowing dynamic adaptation to changing network conditions, ensuring optimal scheduling and resource allocation without requiring a fixed prioritization criterion. Thus, various aspects of the present disclosure may improve system reliability as the UE is configured to handle DCI contention without erroneously interpretating or missing control signals.

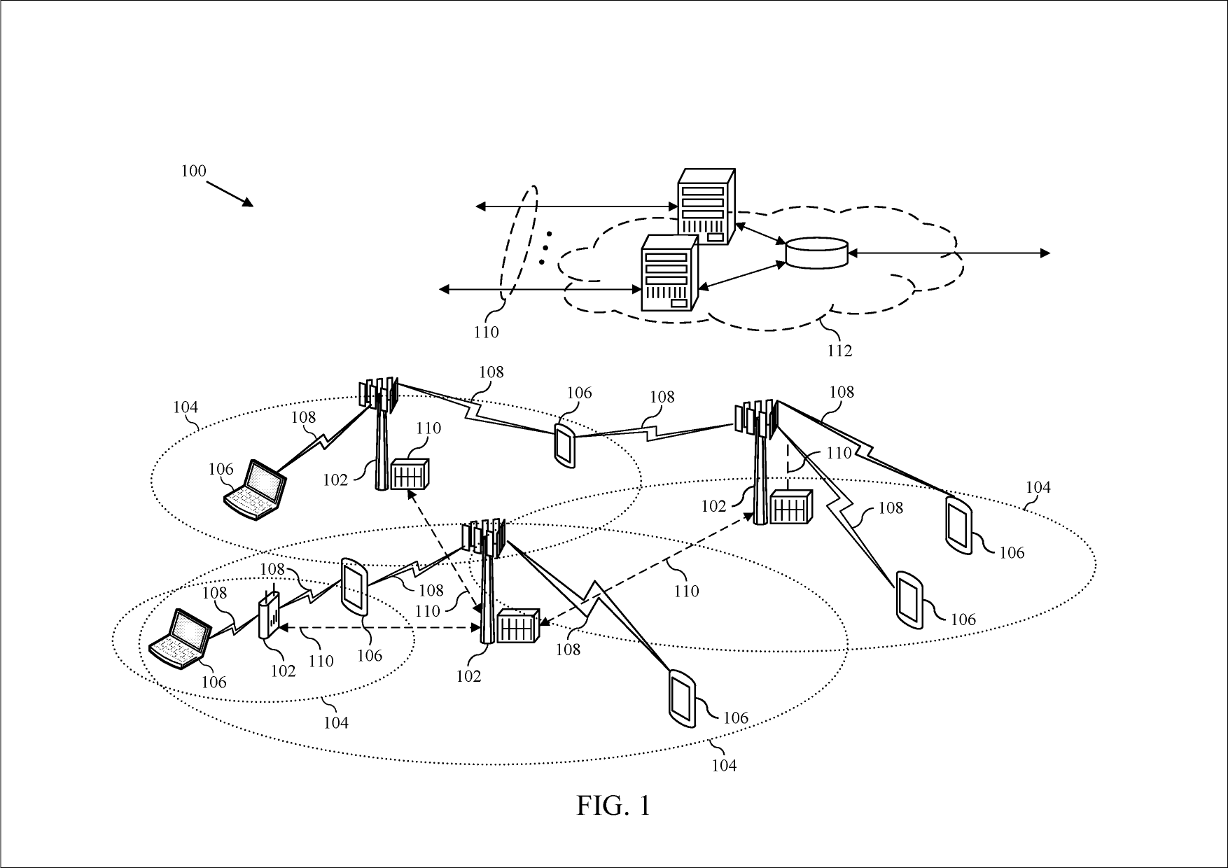

FIG. 1 is a diagram that illustrates an example of a wireless communication system 100, in accordance with certain aspects of the present disclosure. The wireless communication system 100 includes base stations 102, User Equipment (UEs) 106, and a core network 112. In some examples, the wireless communication system 100 may be a Long Term Evolution (LTE) network, an LTE-Advanced (LTE-A) network, an LTE-A Pro network, or a New Radio (NR) network. In some cases, wireless communication system 100 may support enhanced broadband communications, ultra-reliable (e.g., mission critical) communications, low latency communications, or communications with low-cost and low-complexity devices.

Base stations 102 may wirelessly communicate with UEs 106 via one or more base station antennas. The base stations 102 may include or may be referred to by those skilled in the art as Node Bs, home Node Bs, evolved Node Bs (eNBs), next-generation Node Bs (gNBs), home eNBs, access points, base transceiver stations, radio base stations, radio transceivers, transceiver functions, basic service sets (BSSs), extended service sets (ESSs), transmit reception points (TRPs), millimeter wave base stations, or the like. In further aspects, some base stations 102 may be referred to as Radio Access Networks (RANs) and may include aggregated or disaggregated components. For example, in a disaggregated RAN, a base station may include a central unit (CU), one or more distributed units (DUs), and/or one or more remote units (RUs).

Each base station 102 may be associated with a particular geographic coverage area 104 in which communications with various UEs 106 is supported. Each base station 102 may provide communication coverage for a respective geographic coverage area 104 via communication links 108, which may utilize one or more carriers. Communication links 108 shown in wireless communication system 100 may include uplink transmissions from a UE 106 to a base station 102, or downlink transmissions from a base station 102 to a UE 106. Downlink transmissions may also be called forward link transmissions, while uplink transmissions may also be called reverse link transmissions.

The geographic coverage area 104 for a base station 102 may be divided into sectors making up a portion of the geographic coverage area 104, and each sector may be associated with a cell. For example, each base station 102 may provide communication coverage for a macrocell, a small cell, a hot spot, other types of cells, or various combinations thereof. Small cells can further include femtocells (typically used for residential or small business areas), picocells (suited for larger indoor spaces or small outdoor areas), and microcells (providing coverage in medium-sized areas such as campuses or urban zones).

In some aspects, the wireless communication system 100 may be a heterogeneous network that includes the base stations 102 of different types (for example, microcell base stations and small cell base stations) providing coverage for various geographic coverage areas 104. In such aspects, the UEs 106 may communicate with various types of base stations 102 in the wireless communication system 100. In further aspects, the wireless communication system 100 may be a homogenous network that includes the base stations 102 of the same type.

In some examples, a base station 102 may be movable and therefore provide communication coverage for a moving geographic coverage area 104. In some examples, different geographic coverage areas 104 associated with different technologies may overlap, and overlapping geographic coverage areas 104 associated with different technologies may be supported by the same base station 102 or by different base stations 102. In an example scenario, a base station 102, which may be a small cell base station, may have a geographic coverage area 104 that overlaps geographic coverage areas 104 of one or more other base stations 102 such as macro cell base stations.

The term “cell” may refer to a logical communication entity used for communication with a base station 102 (e.g., over a carrier), and may be associated with an identifier for distinguishing neighboring cells (e.g., a physical cell identifier “PCID” and a virtual cell identifier “VCID”) operating via the same or a different carrier. In some examples, a carrier may support multiple cells, and different cells may be configured according to different protocol types (e.g., machine-type communication “MTC”, narrowband Internet-of-Things “NB-IoT”, enhanced mobile broadband “eMBB”, or others) that may provide access for different types of devices. In some cases, the term “cell” may refer to a portion of a geographic coverage area 104 (e.g., a sector) over which the logical entity operates.

The UEs 106 may be dispersed throughout the wireless communication system 100, and each UE 106 can be stationary or mobile. The UEs 106 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network. Examples of the UEs 106 may include a cellular phone, a smart phone, a session initiation protocol (SIP) phone, a laptop, a tablet, a personal digital assistant (PDA), a satellite radio, a global positioning system, a multimedia device, a video device, a digital audio player (e.g., an MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. The UE 106 may also refer to a wireless local loop (WLL) station, an Internet of Things (IoT) device, an Internet of Everything (IoE) device, an MTC device, or the like, which may be implemented in various articles such as appliances, vehicles, meters, or the like.

Some UEs 106, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 102 without human intervention. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In some cases, the UEs 106 may be designed to support critical functions (e.g., mission critical functions), and a wireless communication system 100 may be configured to provide ultra-reliable communications for these functions.

In some cases, a UE 106 may also be able to communicate directly with other UEs 106 (e.g., using a peer-to-peer “P2P” or device-to-device “D2D” protocol). One or more of a group of UEs 106 utilizing D2D communications may be within the geographic coverage area 104 of a base station 102. Other UEs 106 in such a group may be outside the geographic coverage area 104 of a base station 102, or be otherwise unable to receive transmissions from a base station 102. In some cases, groups of UEs 106 communicating via D2D communications may utilize a one-to-many (1:M) system in which each UE 106 transmits to every other UE 106 in the group. In some cases, a base station 102 facilitates the scheduling of resources for D2D communications. In other cases, D2D communications are carried out between UEs 106 without the involvement of a base station 102.

Base stations 102 may communicate with the core network 112 and with one another. For example, base stations 102 may interface with the core network 112 through backhaul links 110 (e.g., via an S1, N2, N3, or other interface). Base stations 102 may communicate with each other over backhaul links 110 (e.g., via an X2, Xn, or any interface) either directly (e.g., directly between base stations 102) or indirectly (e.g., via the core network 112).

The core network 112 may provide user authentication, access authorization, tracking, Internet Protocol (IP) connectivity, and other access, routing, or mobility functions. The core network 112 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 106 served by base stations 102 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network nodes, such as a base station 102, may include subcomponents such as an access network entity, which may be an example of an access node controller (ANC). Each access network entity may communicate with UEs 106 through a number of other access network transmission entities, which may be referred to as a radio head, a smart radio head, or a transmission/reception point (TRP). In some configurations, various functions of each access network entity or base station 102 may be distributed across various network nodes (e.g., radio heads and access network controllers) or consolidated into a single network node (e.g., a base station 102).

In many aspects, the wireless communication system 100 may operate using one or more frequency bands, for example, an ultra-high frequency (UHF) region, a super high frequency (SHF) region, an extremely high frequency (EHF) region, or the like. Techniques disclosed herein may be employed across transmissions that use one or more different frequency regions, and designated use of bands across these frequency regions may differ by country or regulating body. In further aspects, the wireless communication system 100 may utilize both licensed and unlicensed radio frequency spectrum bands. For example, wireless communication system 100 may employ License Assisted Access (LAA), LTE-Unlicensed (LTE-U) radio access technology, or NR technology in an unlicensed band such as the 5 GHz ISM band.

In further aspects, the base stations 102 and the UEs 106 may each include a plurality of antennas, such as antenna elements, antenna panels, and/or antenna arrays to facilitate beamforming. The communication links 108 may use multiple-input and multiple-output (MIMO) antenna technology, including spatial multiplexing, beamforming, and/or transmit diversity.

“Beamforming”, which may also be referred to as spatial filtering, directional transmission, or directional reception, is a signal processing technique that may be used at a transmitting device or a receiving device (e.g., a base station 102 or a UE 106) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 102 may use multiple antennas or antenna arrays to conduct beamforming operations for directional communications with a UE 106. For example, some signals (e.g., synchronization signals, reference signals, beam selection signals, or other control signals) may be transmitted by a base station 102 multiple times in different directions, which may include a signal being transmitted according to different beamforming weight sets associated with different directions of transmission. Transmissions in different beam directions may be used to identify (e.g., by the base station 102 or a receiving device, such as a UE 106) a beam direction for subsequent transmission and/or reception by the base station 102.

In some aspects, the antennas of a base station 102 or UE 106 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 102 may be located in diverse geographic locations. A base station 102 may have an antenna array with a number of rows and columns of antenna ports that the base station 102 may use to support beamforming of communications with a UE 106. Likewise, a UE 106 may have one or more antenna arrays that may support various MIMO or beamforming operations.

In some aspects, wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 106 and a base station 102 or core network 112 supporting radio bearers for user plane data. At the Physical layer, transport channels may be mapped to physical channels.

Time intervals in LTE or NR may be expressed in multiples of a basic time unit, which can correspond to a sampling period. The time intervals of a communications resource may be structured into radio frames, each spanning a defined duration. These radio frames can be identified by a system frame number (SFN) within a predetermined range. Each frame may include multiple subframes, each with a set duration, and these subframes can be further divided into slots, which contain a specific number of modulation symbol periods. For example, a basic time unit may correspond to a sampling period of 1/30,720,000 seconds. A radio frame can have a duration of 10 milliseconds and may be expressed in terms of a specific number of sampling periods. The SFN may range from 0 to 1023. Each radio frame can include 10 subframes, each lasting 1 millisecond, with subframes further divided into slots, such as two slots of 0.5 milliseconds each. The number of modulation symbol periods per slot can depend on a cyclic prefix length, with each symbol period containing a defined number of sampling periods. In some aspects, a subframe may serve as the smallest scheduling unit of the wireless communication system 100 and can be referred to as a transmission time interval (TTI). In further aspects, the smallest scheduling unit may be shorter than a subframe or dynamically determined, such as in bursts of shortened TTIs (sTTIs) or in selected component carriers using sTTIs.

In some wireless communication systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communication systems may implement slot aggregation in which multiple slots or mini-slots are aggregated together and used for communication between a UE 106 and a base station 102.

The term “carrier” may refer to a set of radio frequency spectrum resources having a defined physical layer structure for supporting communications over a communication link 108. For example, a carrier of a communication link 108 may include a portion of a radio frequency spectrum band that is operated according to physical channels for a given radio access technology. Each physical channel may carry user data, control information, or other signaling. A carrier may be associated with a pre-defined frequency channel (e.g., an evolved universal mobile telecommunication system terrestrial radio access “E-UTRA” absolute radio frequency channel number “EARFCN”), and may be positioned according to a channel raster for discovery by UEs 106. Carriers may be downlink or uplink (e.g., in a Frequency Division Duplexing mode), or be configured to carry downlink and uplink communications (e.g., in a Time Division Duplexing mode). In some examples, signal waveforms transmitted over a carrier may be made up of multiple sub-carriers (e.g., using multi-carrier modulation “MCM” techniques such as orthogonal frequency division multiplexing “OFDM” or discrete Fourier transform spread OFDM “DFT-S-OFDM”).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel (e.g., a physical downlink control channel “PDCCH”) and a physical data channel (e.g., a Physical Downlink Shared Channel “PDSCH”) may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner.

A Physical Downlink Control Channel (PDCCH) may carry Downlink Control Information (DCI) using control channel elements (CCEs), which are composed of multiple resource element groups (REGs), each containing a defined number of resource elements (REs). DCI can include details related to downlink scheduling assignments, uplink resource grants, transmission schemes, uplink power control, HARQ information, modulation and coding scheme (MCS), and additional or alternate signaling information. The size and format of DCI messages can vary based on a type and amount of information the DCI messages carry. For example, if spatial multiplexing is supported, a DCI message size can be larger compared to cases with contiguous frequency allocations. Similarly, in systems employing MIMO, additional signaling may be included in the DCI. In other words, DCI size and format can depend on multiple factors, such as bandwidth, a number of antenna ports, and a duplexing mode.

A PDCCH may carry DCI messages for multiple UEs 106, with each UE 106 decoding only the DCI messages intended for the corresponding UE 106. To reduce power consumption and signaling overhead at the UE 106, a limited set of CCE locations can be specified for DCI messages related to the UE 106. In an example, CCEs may be grouped into predefined sizes (e.g., 1, 2, 4, or 8 CCEs per group), and a specific set of CCE locations where a UE 106 may find a relevant DCI can be defined. Such a set of CCEs may be referred to as a search space. For example, if a UE 106 is assigned a search space of CCEs [4, 5, 6, 7], the UE 106 may only check the CCEs [4, 5, 6, 7] for DCI, thereby saving power.

In various examples, the search space can be divided into two regions: a common search space (CSS) and a UE-specific search space (UE-SS). The CSS, monitored by multiple UEs 106 served by a base station 102, may include system-wide messages. For example, paging messages (which notify a UE 106 of an incoming call or message), system information blocks (SIBs) that provide network configuration, and random access procedures (used when a UE 106 first connects to the network) may be included in the CSS. In contrast, the UE-SS may include user-specific control information, such as scheduling grants or power control commands for an individual UE 106.

In additional examples, CCEs may be indexed and the CSS may start at CCE index 0. A starting index for the UE-SS may depend on various factors, including the Cell Radio Network Temporary Identifier (C-RNTI), a subframe index, a CCE aggregation level, and a random seed. For example, if a UE 106 has a C-RNTI of 12345, the network may utilize the C-RNTI value along with the subframe index to determine where the UE 106 can look for DCI in a scheduling instance.

In many aspects, search spaces may be organized within a Control Resource Set (CORESET), which defines a specific time-frequency region where PDCCH transmissions occur. A CORESET may include multiple CCEs, which serve as the smallest unit of PDCCH resource allocation. The number of CCEs in a CORESET may determine how much control information can be transmitted, and the number of CCEs can vary based on network configuration and UE configuration. For example, if a CORESET includes CCEs indexed from 0 to 47, a UE’s assigned search space in CCE locations [4, 5, 6, 7] is within the CORESET boundaries. In other words, each search space (e.g., CSS or UE-SS) is mapped to a CORESET.

A UE 106 may attempt to decode DCI by performing a process known as a blind decode, during which search spaces are decoded until the DCI is detected. During a blind decode, the UE 106 may attempt descrambling potential DCI messages using corresponding C-RNTI, and perform a Cyclic Redundancy Check (CRC) to determine whether the descrambling attempt was successful.

In many aspects, different DCI formats are used to convey control signaling to the UE 106, depending on the transmission scenario and scheduling configurations. For example, the DCI formats can be categorized into fallback and non-fallback types. DCI format 0_0 (uplink scheduling) and DCI format 1_0 (downlink scheduling) are examples of two fallback DCI formats, and DCI format 0_1 (uplink) and DCI format 1_1 (downlink) are examples of two non-fallback DCI formats.

In many scenarios, a UE 106 may be in a region where the assigned CSS and UE-SS overlap. For example, the assigned CSS and UE-SS are associated with same CORESET and have at least one overlapping PDCCH monitoring occasion. The overlap in the CSS and the UE-SS can lead to simultaneous reception of multiple DCIs, for example, one for the CSS and one for the UE-SS. In an example, a UE 106 may concurrently receive fallback DCI on CSS and non-fallback DCI on UE-SS within a same PDCCH monitoring occasion. In further aspects, the fallback DCI (Format 0_0/1_0) and the non-fallback DCI (Format 0_1/1_1) can have identical payload sizes and may be transmitted over same CCEs with same scrambling identifiers. In such a scenario without conflict resolution, the UE 106 may be unable to correctly differentiate between the fallback DCI and the non-fallback DCI, which can lead to incorrect processing of control information. The UE 106 can also prioritize the wrong DCI, causing failures in resource allocation, scheduling, or fallback procedures. In cases where the UE incorrectly assumes a non-fallback DCI when a fallback is expected or assumes a fallback DCI when a non-fallback is expected, performance may degrade, connectivity may be lost, or spectrum utilization may become inefficient. Additionally, misinterpretation of the DCI may cause retransmissions, increasing network congestion and latency.

In various aspects, the wireless communication system 100 may support resolution of the above-described DCI conflicts. For example, the UE 106, upon detecting simultaneous DCI reception (e.g., fallback DCI and non-fallback DCI) within overlapping CSS and UE-SS, may apply at least one criterion to prioritize one of the fallback DCI or the non-fallback DCI and process the DCI which is prioritized. Thus, eliminating DCI misinterpretations at the UE 106.

In many aspects, the at least one criterion can be based on a default prioritization criterion configured within UE’s processing system or a network configurable criterion transmitted to the UE 106 by the base stations 102 or the core network 112. In various aspects, the base stations 102 may communicate with the core network 112 to receive configuration instructions and transmit corresponding DCI messages to UEs 106 within their coverage areas 104. In scenarios where DCI contention is anticipated (e.g., in cases where CSS and UE-SS overlap in time and frequency domain), the base station 102 may utilize the network configurable criterion to instruct the UE 106 on whether to prioritize fallback DCI or non-fallback DCI, thereby eliminating misinterpretations and reducing unnecessary bandwidth part (BWP) switching at the UE 106.

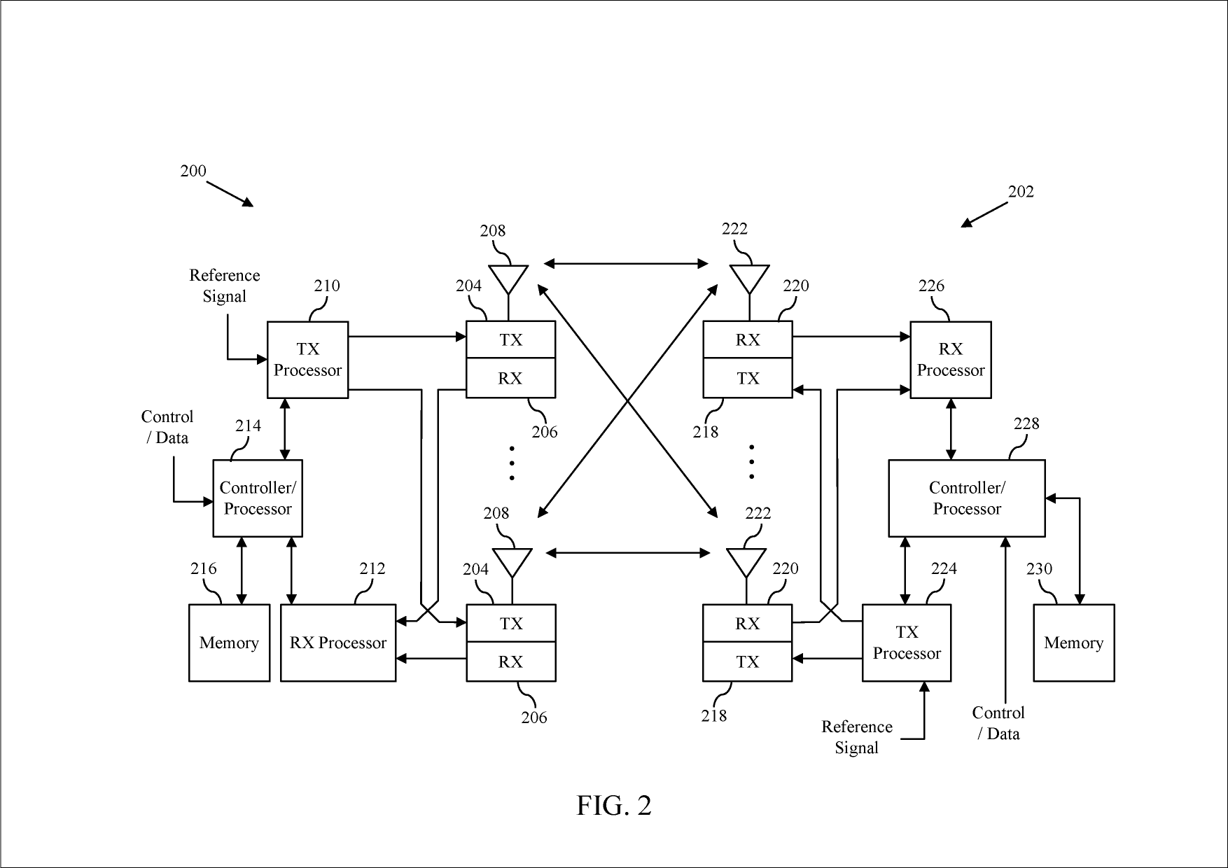

FIG. 2 is a block diagram illustrating an example of a base station 200 and UE 202 in a wireless communication system, in accordance with certain aspects. FIG. 2 is described in conjunction with FIG. 1. The base station 200 shown in FIG. 2 may be similar to the base station 102 shown in FIG. 1. Likewise, the UE 202 shown in FIG. 2 may be similar to the UE 106 shown in FIG. 1.

In various aspects, the base station 200 may include one or more transmitters (TX) 204 and one or more receivers (RX) 206. Each TX 204 and RX 206 may be coupled to a corresponding antenna 208. Each TX 204 may be coupled to a TX processor 210, and each RX 206 may be coupled to an RX processor 212. The base station 200 may further include a controller/processor 214 coupled to the TX processor 210, the RX processor 212, and a memory 216.

In various aspects, the UE 202 may include one or more TX 218 and one or more RX 220. Each TX 218 and RX 220 may be coupled to a corresponding antenna 222. Each TX 218 may be coupled to a TX processor 224, and each RX 220 is coupled to the RX processor 226. The UE 202 may further include a controller/processor 228 coupled to the TX processor 224, the RX processor 226, and a memory 230.

In many aspects, the TX processor 210 may be configured to generate downlink control signals, including DCI, which are then transmitted to the UE 202 via the TX 204. The base station 200 may receive uplink transmissions from the UE 202 through the RX 206, which then passes the received uplink transmissions to the RX processor 212. The controller/processor 214 may be configured to govern control procedures, including managing contention scenarios when multiple DCIs with identical sizes are scheduled over the same CORESET.

In various aspects, the base station 200 may configure the UE 202 with a CORESET spanning a CSS and a UE-SS in a manner that results in temporal and frequency-domain overlap. This can lead to one or more overlapping PDCCH monitoring occasions, where the UE 202 may be configured to monitor both CSS and UE-SS within the same monitoring occasion. In one such overlapping PDCCH monitoring occasion, the base station 200 may transmit fallback DCI on the CSS and non-fallback DCI on the UE-SS, potentially leading to contention, such as a DCI conflict. In many further aspects, the fallback DCI and the non-fallback DCI may have the same sizes and can be transmitted over the same CCEs with the same scrambling IDs. As a result, the UE 202 may encounter contention, for example, the DCI conflict, when the fallback DCI on the CSS (e.g., a first search space) and the non-fallback DCI on the UE-SS (e.g., a second search space) are concurrently received within the overlapping PDCCH monitoring occasion.

Various aspects of the present disclosure introduce at least one criterion that enables the UE 202 to process the correct DCI format (e.g., one of the concurrently received fallback DCI or the non-fallback DCI) in case of the DCI conflict as described above.

In many aspects, the controller/processor 228 may be configured to apply the at least one criterion to prioritize one of the concurrently received fallback and non-fallback DCIs in case of the DCI conflict. For example, in case of the DCI conflict, the controller/processor 228 may apply the at least one criterion and prioritize the fallback DCI on the CSS over the non-fallback DCI on the UE-SS in a case where the fallback DCI and the non-fallback DCI are received with identical sizes and scrambling IDs in the same CCEs.

In several aspects, the at least one criterion can correspond to a default prioritization criterion of the UE 202. For example, the default prioritization criterion can be pre-configured in UE’s firmware or stored in the memory 230. In many aspects, the default prioritization criterion can also be embedded as part of UE’s processing logic within the controller/processor 228, allowing the default prioritization criterion to be executed autonomously during the DCI conflict. In more aspects, the default prioritization criterion may be defined (for example, as configuration settings or as a ruleset) in system specifications and implemented in UE’s software stack, enabling consistent decision-making when resolving a DCI conflict. In certain aspects, depending on implementation, the default prioritization criterion can be stored in non-volatile memory (e.g., the memory 230) for persistent configurations.

In several additional aspects, the at least one criterion can correspond to a network configurable prioritization criterion that resolves the conflict between the fallback DCI and the non-fallback DCI that are concurrently received. In an example, the base station 200 can provide the network configurable prioritization criterion to the UE 202 via an indication in an information element (IE) of an RRC message. In other words, the TX processor 210 can configure the network configurable prioritization criterion in an RRC message and transmit the RRC message to the UE 202, allowing network operators to define prioritization rules dynamically.

In various aspects, the base station 200 can transmit the indication regarding the network configurable prioritization criterion at various time instances, for example, at the time of establishment of an initial connection between the UE 202 and the base station 200 or dynamically at the time when the base station 200 detects a conflicting prioritization scenario that involves an update. Additionally, the network configurable prioritization criterion can be re-configured during handover procedures, upon receiving a system information update, or based on specific network-triggered events that involve a re-assessment of the prioritization rule.

In various aspects, the UE 202, upon receiving the indication regarding the network configurable prioritization criterion, can store the network configurable prioritization criterion in a volatile memory (e.g., the memory 230) or a dedicated memory segment of the memory 230 that allows overwriting in case the network configurable prioritization criterion is updated or reconfigured by the base station 200. The utilization of the network configurable prioritization criterion may enable adaptability to changing network conditions and policy updates.

In many aspects, the UE 202 may be configured to monitor the CSS and UE-SS. In a scenario where a PDCCH monitoring occasion overlaps for the CSS and UE-SS having the same CORESET, the UE 202 may receive two DCIs within the same PDCCH monitoring occasion, one associated with the CSS and one with the UE-SS. Further, the received DCIs may have the same sizes and may be transmitted over the same CCEs using the same scrambling IDs. In such a scenario, the controller/processor 228 may be configured to decode the received DCIs and determine corresponding DCI formats. In an example, the controller/processor 228 may decode the received DCIs to classify the DCI format as either 0_0/1_0 (associated with fallback DCI) or 0_1/1_1 (associated with non-fallback DCI).

Once the corresponding DCI formats are determined, the controller/processor 228 may be configured to apply the at least one criterion and prioritize one of the fallback DCI having the DCI format 0_0/1_0 or the non-fallback DCI having the DCI format 0_1/1_1. In an example, the controller/processor 228 may prioritize the fallback DCI over the non-fallback DCI based on the at least one criterion.

After establishing the priority, the controller/processor 228 may be configured to process one of the fallback DCI or the non-fallback DCI that is prioritized and optionally discard one of the fallback DCI or the non-fallback DCI that is non-prioritized. For example, the controller/processor 228 may process the fallback DCI that is prioritized. Based on the prioritization of the fallback DCI, the non-fallback DCI may have a lower priority than the fallback DCI. In such a scenario, the controller/processor 228 may discard the non-fallback DCI having the lower priority than the fallback DCI. In other words, the controller/processor 228 may select the higher-priority DCI for processing and optionally discard the lower-priority DCI.

Though the above examples describe a reception of concurrent DCIs over CSS and UE-SS, the scope of the disclosure is not limited to it. In various aspects, the fallback and non-fallback DCI overlap can occur between two UE-SSs of the UE 106. The UE 106 can have the at least one criterion (either the default or the network configurable prioritization criterion) that aids in establishing DCI priority.

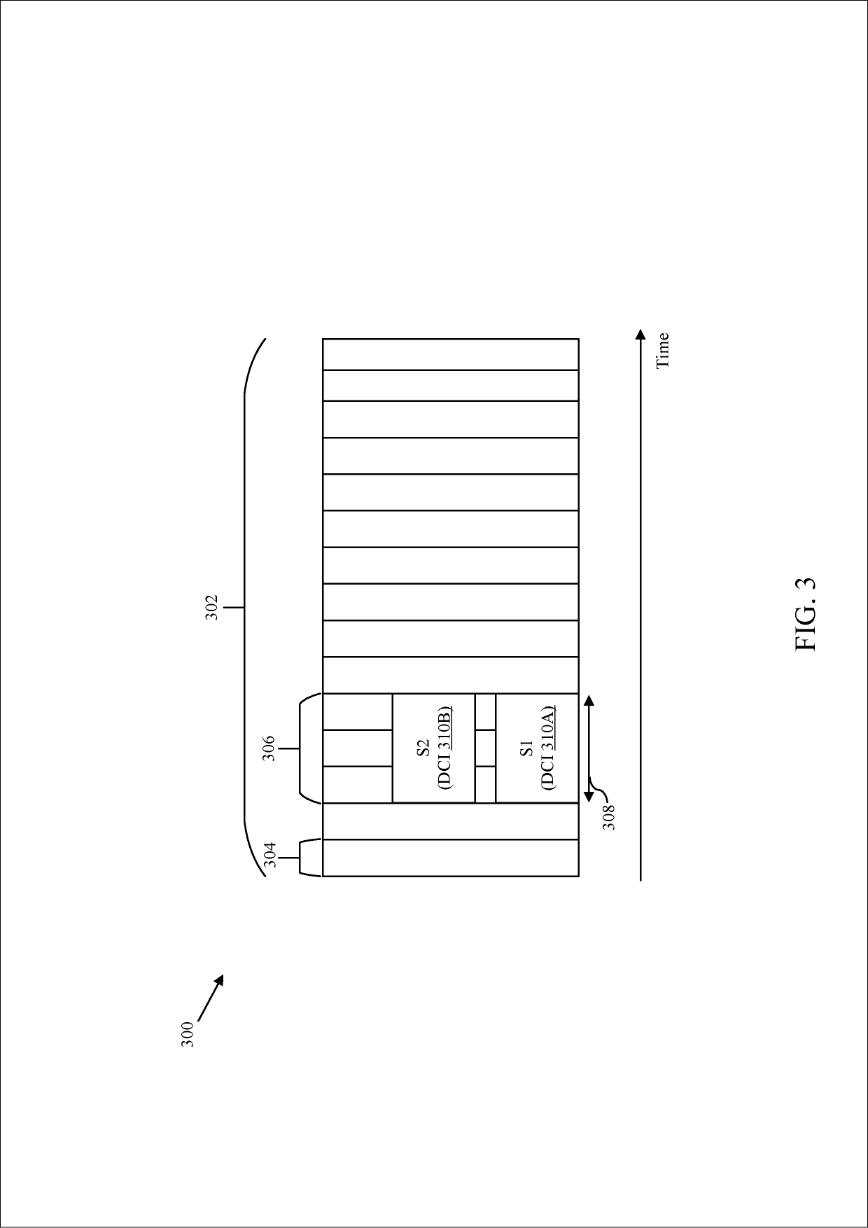

FIG. 3 is a diagram illustrating an example of a resource diagram 300 with an overlapping monitoring session for two search spaces, in accordance with certain aspects of the present disclosure. FIG. 3 is described in conjunction with FIGS. 1 and 2. In some examples, the resource diagram 300 may implement aspects of the wireless communication system 100, the base station 200, and the UE 202.

In various aspects, the resource diagram 300 may include a slot 302 including multiple symbols 304. The slot 302 may be monitored for PDCCH candidates (for example, by the UE 202) and configured with one or more monitoring occasions of a first search space S1 and one or more monitoring occasions of a second search space S2. In many examples, the first search space S1 and the second search space S2 may be associated with a same CORESET 306 (for example, of three symbols 304) and may have one or more overlapping PDCCH monitoring occasions. One such overlapping PDCCH monitoring occasion 308 is shown in FIG. 3.

In various aspects, the CORESET 306 may refer to a dedicated set of frequency and time resources allocated for control signaling within the slot 302. The CORESET 306 may carry the PDCCH, which contains DCI messages used for scheduling uplink and downlink transmissions. The CORESET 306 may define where and how a gNB (base station) transmits DCI to the UE 202. Further, a PDCCH monitoring occasion may correspond to a specific time instance when the UE 202 is expected to monitor the PDCCH for DCI.

In some cases, the slot 302 may include multiple monitoring occasions of the first search space S1, but may include a single monitoring occasion of the second search space S2. In such a scenario, the single monitoring occasion of the second search space S2 may overlap with one of the multiple monitoring occasions of the first search space S1. In certain cases, the slot 302 may include multiple monitoring occasions of the second search space S2, but may include a single monitoring occasion of the first search space S1. In such a scenario, the single monitoring occasion of the first search space S1 may overlap with one of the multiple monitoring occasions of the second search space S2. In more aspects, there may be multiple monitoring occasions of both the first search space S1 and the second search space S2, one or more of which may overlap.

In an example, the first search space S1 may correspond to CSS and the second search space S2 may correspond to UE-SS. The CSS may be reserved for system-wide control signaling and utilized to carry fallback DCI (Format 0_0/1_0). The fallback DCI may include random access responses (RAR), paging messages, and system information updates, for example. Since the CSS is intended for connected UEs within a network system, a failure in decoding the Fallback DCI may result in signaling loss for the UE. The UE-SS, on the other hand, may be dedicated to individual UEs (e.g., the UE 202) and can be used to carry non-fallback DCI (Format 0_1/1_1). The non-fallback DCI format may be used for scheduling downlink and uplink transmissions, HARQ feedback, and other UE-specific operations. Unlike CSS, which serves multiple UEs, the UE-SS is tailored for a single UE.

Since the first search space S1 and the second search space S2 are mapped to the same CORESET 306, the UE 202 may be configured to monitor PDCCH candidates from the first search space S1 and the second search space S2 within the same symbol duration. In an example, during the overlapping PDCCH monitoring occasion 308, fallback DCI 310A may be transmitted on the first search space S1 and non-fallback DCI 310B may be concurrently transmitted on the second search space S2. In further examples, the fallback DCI 310A and the non-fallback DCI 310B may have identical payload sizes and the same scrambling identifiers. The UE 202 may resolve the conflict between the concurrently received fallback DCI 310A and the non-fallback DCI 310B by leveraging the at least one criterion (e.g., the default prioritization criterion or the network configurable prioritization criterion) as described in FIGS. 1 and 2.

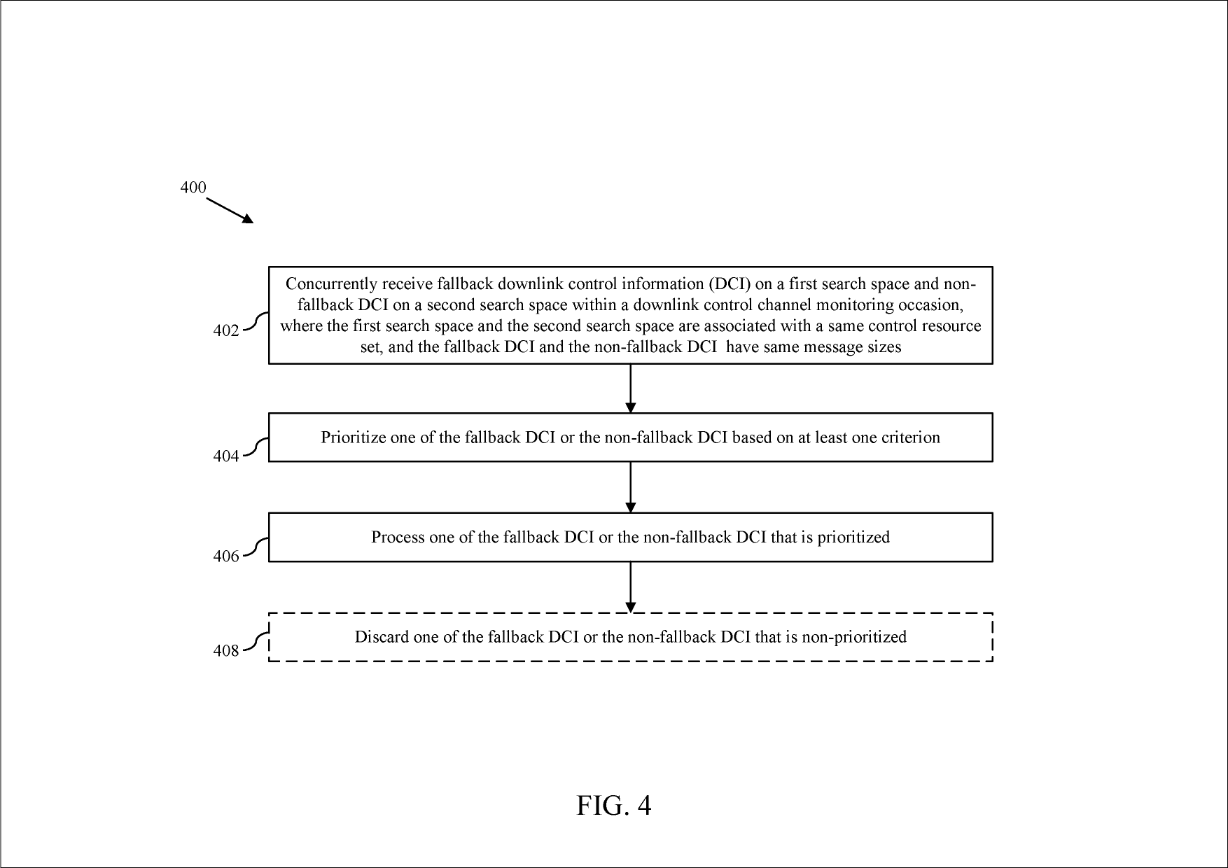

FIG. 4 is a flowchart that illustrates a method (e.g., a process) executed at a UE for managing DCI conflict in wireless communication, in accordance with an exemplary aspect of the present disclosure. In many examples, the UE can be the UE 106 or the UE 202 described in the foregoing description of FIGS. 1 – 3. Referring to FIG. 4, there is shown a flowchart 400 that illustrates exemplary operations 402 through 408 for the UE for managing DCI conflict in wireless communication. In a non-limiting example, the flowchart 400 is explained with reference to the UE 202 of FIG. 2.

At 402, fallback DCI on a first search space and non-fallback DCI on a second search space may be concurrently received within a downlink control channel monitoring occasion. The first search space and the second search space may be associated with a same CORESET (e.g., the CORESET 306), and the fallback DCI and the non-fallback DCI may have same message sizes. For example, the UE 202 may concurrently receive the fallback DCI 310A on the first search space S1 and the non-fallback DCI 310B on the second search space S2 during the same PDCCH monitoring occasion 308. In other words, one or more processors (e.g., the controller/processor 228, the TX processor 224, the RX processor 226) of the UE 202 may be individually or collectively configured to concurrently receive the fallback DCI 310A on the first search space S1 and the non-fallback DCI 310B on the second search space S2 within the PDCCH monitoring occasion 308.

In an example, the first search space S1 may correspond to the CSS assigned to the UE 202 for system-wide signaling, while the second search space S2 may correspond to the UE-SS intended for UE-specific scheduling. In further aspects, both search spaces (such as the first search space S1 and the second search space S2) may be mapped to the same CORESET 306 and have the same PDCCH monitoring occasion 308. Further, the fallback DCI 310A and the non-fallback DCI 310B may be associated with the same CCEs within the CORESET 306. Furthermore, the fallback DCI 310A and the non-fallback DCI 310B may have same (e.g., identical) sizes and may be associated with same scrambling IDs.

At 404, one of the fallback DCI or the non-fallback DCI may be prioritized based on at least one criterion. For example, the UE 202 may be configured to prioritize one of the fallback DCI 310A or the non-fallback DCI 310B based on the at least one criterion as described in the foregoing description of FIGS. 1 – 3. In other words, the one or more processors (e.g., the controller/processor 228, the TX processor 224, the RX processor 226) of the UE 202 may be individually or collectively configured to prioritize one of the fallback DCI 310A or the non-fallback DCI 310B based on the at least one criterion. In an example, the at least one criterion may include at least one of the default prioritization criterion or the network configurable prioritization criterion as described in the foregoing description of FIG. 2.

At 406, one of the fallback DCI or the non-fallback DCI that is prioritized may be processed. For example, the UE 202 may be configured to process one of the fallback DCI 310A or the non-fallback DCI 310B that is prioritized at 404. In other words, the one or more processors (e.g., the controller/processor 228, the TX processor 224, the RX processor 226) of the UE 202 may be individually or collectively configured to process one of the fallback DCI 310A or the non-fallback DCI 310B that is prioritized.

Once the UE 202 has identified whether to process the fallback DCI 310A (Format 0_0/1_0 on CSS) or the non-fallback DCI 310B (Format 0_1/1_1 on UE-SS), the UE 202 may execute one or more instructions in the prioritized DCI. In various aspects, processing of a DCI may involve decoding a payload of the DCI and extracting relevant control information, which may include: Downlink/Uplink scheduling assignments, Resource allocation details, HARQ feedback, BWP switching commands, RAR, Power control commands, or other system-level signaling relevant to the UE’s operation.

For example, the fallback DCI 310A (Format 0_0) on the CSS may be prioritized over the non-fallback DCI 310B (Format 0_1) on the UE-SS due to the default prioritization criterion. In such a scenario, if the prioritized fallback DCI 310A contains an uplink grant for a RAR, the UE 202 may process the fallback DCI 310A and proceed with the scheduled uplink transmission to complete the random access procedure.

Alternatively, if the base station 200 coupled to the UE 202 has configured non-fallback DCI (Format 0_1) in UE-SS with higher priority (e.g., for low-latency URLLC scheduling) via the network configurable prioritization criterion, the UE 202 may decode and process the non-fallback DCI 310B. In such a case, if the non-fallback DCI 310B is for scheduling an urgent downlink transmission for a real-time voice or autonomous vehicle control packet, the UE 202 may prepare to receive the scheduled data, ensuring low-latency service delivery.

Thus, the UE 202 may execute commands included in the prioritized DCI and avoid conflicts arising from simultaneous DCI reception. In other words, with such structured prioritization and processing mechanism, misinterpretation of the received control signaling, operational failures such as unintended BWP switches, missed scheduling opportunities, random access procedure failures, inefficient HARQ retransmissions, and increased latency for critical services may be eliminated.

At 408, one of the fallback DCI or the non-fallback DCI that is non-prioritized may be discarded. For example, the UE 202 may optionally discard the non-prioritized DCI to avoid ambiguity in interpreting control signaling. In other words, the one or more processors (e.g., the controller/processor 228, the TX processor 224, the RX processor 226) of the UE 202 may be individually or collectively configured to discard one of the fallback DCI 310A or the non-fallback DCI 310B that is non-prioritized.

In scenarios where fallback DCI (Format 0_0/1_0 in CSS) and non-fallback DCI (Format 0_1/1_1 in UE-SS) are received simultaneously with the same payload size and scrambling IDs, the UE 202 may discard one to prevent misinterpretation of network commands. The discarded DCI may not be processed. For example, various scheduling, grants, or control information in the discarded DCI are ignored.

For example, the UE 202 may receive two DCIs in an overlapping PDCCH monitoring occasion, one being fallback DCI on the CSS and another being non-fallback DCI on the UE-SS. If the default prioritization criterion defines that the fallback DCI takes precedence, the non-fallback DCI may be discarded.

In further examples, if the network configurable prioritization criterion specifies that non-fallback DCI takes precedence over the fallback DCI during a DCI conflict as described in the foregoing description, the fallback DCI may be discarded. This may be applicable in scenarios where network dynamically adjusts scheduling priority, for instance, in Ultra-Reliable Low Latency Communication (URLLC) services, where time-sensitive data scheduling takes precedence over fallback signaling. In such a scenario, discarding the fallback DCI may enable the UE 202 to process the high-priority UE-specific instructions, minimizing latency and optimizing resource utilization.

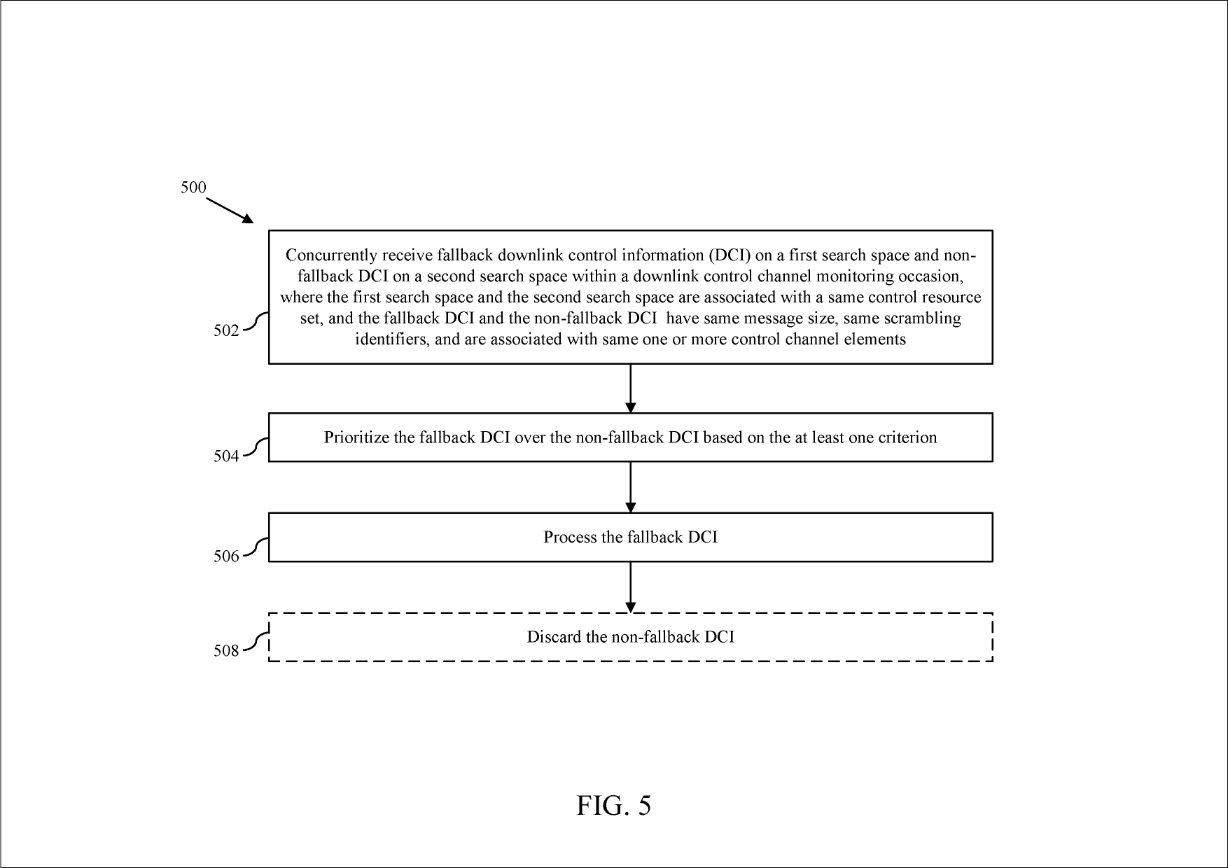

FIG. 5 is a flowchart that illustrates a method (e.g., a process) executed at a UE for managing DCI conflict in wireless communication, in accordance with an exemplary aspect of the present disclosure. In many examples, the UE can be the UE 106 or the UE 202 described in the foregoing description of FIGS. 1 – 4. Referring to FIG. 5, there is shown a flowchart 500 that illustrates exemplary operations 502 through 508 for the UE to manage DCI conflict in wireless communication. In a non-limiting example, the flowchart 500 is explained with reference to the UE 202 of FIGS. 1 – 4.

At 502, fallback DCI on a first search space and non-fallback DCI on a second search space may be concurrently received within a downlink control channel monitoring occasion. The first search space and the second search space may be associated with a same CORESET, and the fallback DCI and the non-fallback DCI may have same message size, same scrambling identifiers, and may be associated with same one or more CCEs. For example, the one or more processors (e.g., the controller/processor 228, the TX processor 224, the RX processor 226) of the UE 202 may be individually or collectively configured to concurrently receive the fallback DCI 310A on the first search space S1 and the non-fallback DCI 310B on the second search space S2 within the PDCCH monitoring occasion 308. In an example, the first search space S1 may correspond to a CSS and the second search space S2 may correspond to a UE-SS.

At 504, the fallback DCI may be prioritized over the non-fallback DCI based on the at least one criterion. For example, the one or more processors (e.g., the controller/processor 228, the TX processor 224, the RX processor 226) of the UE 202 may be individually or collectively configured to prioritize the fallback DCI 310A over the non-fallback DCI 310B based on the at least one criterion. In an example, the at least one criterion may include at least one of a default prioritization criterion or a network configurable prioritization criterion as described in the foregoing description of FIG. 2.

In an example, as per the default prioritization criterion, the UE 202 may follow a pre-defined logic to prioritize first DCI having a first DCI format (0_0/1_0) on a CSS over a concurrently received second DCI having a second format (0_1/1_1) on a UE-SS in a case where the CSS and the UE-SS overlap in time and frequency domains and the first DCI and the second DCI have same scrambling identifiers and same sizes. Thus, preventing loss of system-level signaling in fallback DCI (such as system reconfiguration, random access response, or the like) due to contention with scheduling-related non-fallback DCI. In more examples, the UE 202 may utilize the network configurable prioritization criterion to resolve the conflict between the fallback DCI and the non-fallback DCI that are concurrently received.

At 506, the fallback DCI may be processed. For example, the one or more processors (e.g., the controller/processor 228, the TX processor 224, the RX processor 226) of the UE 202 may be individually or collectively configured to process the fallback DCI 310A. In an example, processing the fallback DCI 310A may involve extraction of control information contained within the DCI Format 0_0/1_0. The extracted information may include RAR assignments, Paging Indications, System Information Updates, or BWP switching commands.

For example, in a case where the fallback DCI 310A includes an instruction to switch from an inactive BWP to an active BWP, the UE 202, upon decoding the fallback DCI 310A, may update downlink and uplink configurations to operate in the correct frequency range defined by the fallback DCI 310A.

In some examples, the fallback DCI 310A may include an instruction to schedule a response to the UE’s preamble transmission. The fallback DCI 310A may provide information such as an uplink grant, timing advance commands, and a temporary C-RNTI assignment. Based on such prioritized fallback DCI 310A, the UE 202 may update corresponding transmission parameters and continue with the random access procedure, enabling connection setup with the base station 200.

At 508, the non-fallback DCI may be discarded. For example, the one or more processors (e.g., the controller/processor 228, the TX processor 224, the RX processor 226) of the UE 202 may be individually or collectively configured to optionally discard the non-fallback DCI 310B. In various examples, based on the prioritization of the fallback DCI 310A at 506, the non-fallback DCI 310B may have a lower priority than the fallback DCI 310A. Thus, the one or more processors of the UE 202 may be individually or collectively configured to discard the non-fallback DCI 310B having the lower priority than the fallback DCI 310A. Thus, the UE 202 may not execute conflicting or redundant commands that could arise from simultaneous DCI receptions within the same PDCCH monitoring occasion 308. The decision to discard the non-fallback DCI 310B can be based on the at least one criterion set by the network or defined locally at the UE 202.

For example, the fallback DCI 310A may contain an instruction to switch BWP from a currently inactive state to an active state. Simultaneously, the non-fallback DCI 310B may contain a UE-specific uplink grant scheduled for transmission on the older BWP. If the UE 202 were to process both DCIs, the UE 202 may experience a conflict, such as whether to transmit using the old BWP or to switch to the new BWP, first. Thus, the at least one criterion ensures that the UE 202 discards the non-fallback DCI 310B. As a result, the UE 202 may execute the BWP switch, and wait for a new uplink grant that aligns with the updated configuration.

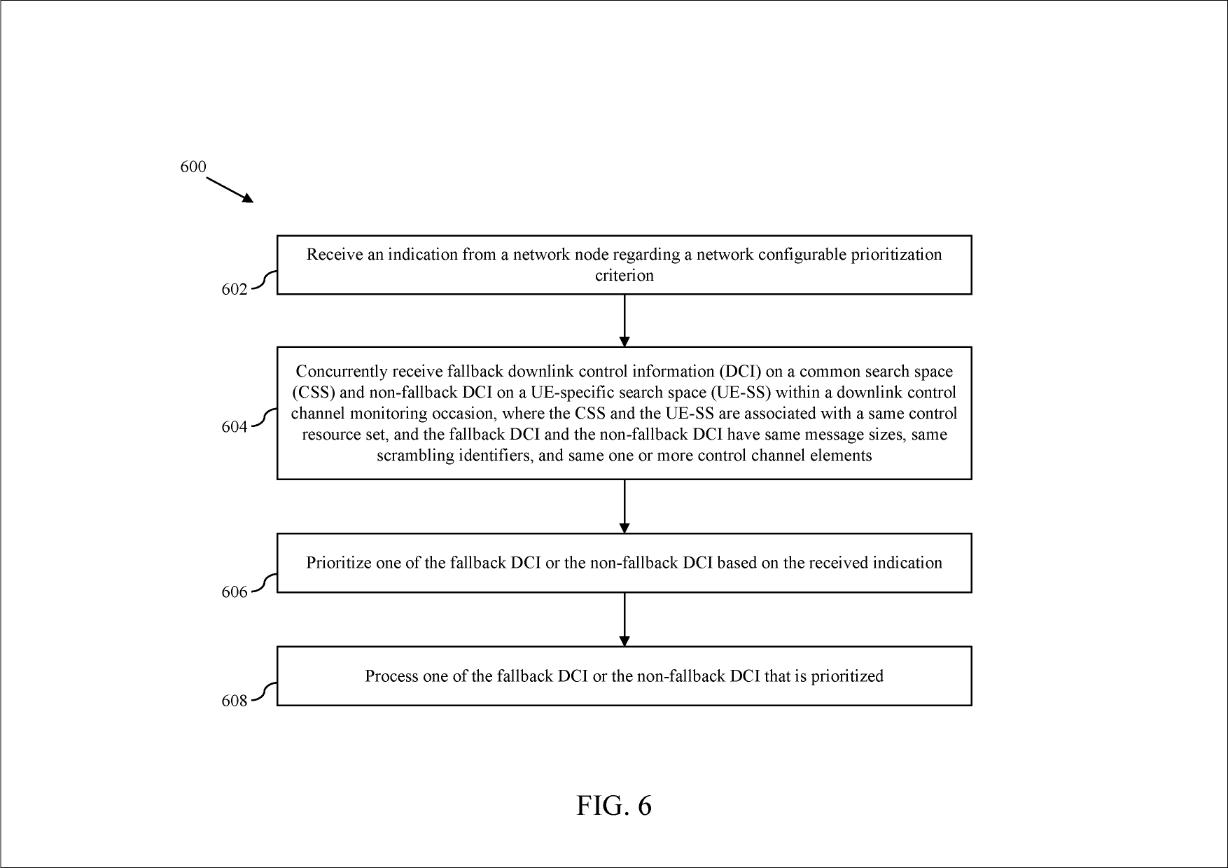

FIG. 6 is a flowchart that illustrates a method (e.g., a process) executed at a UE for managing DCI conflict in wireless communication, in accordance with an exemplary aspect of the present disclosure. In many examples, the UE can be the UE 106, or the UE 202 described in the foregoing description of FIGS. 1 – 5. Referring to FIG. 6, there is shown a flowchart 600 that illustrates exemplary operations 602 through 608 for the UE for managing DCI conflict in wireless communication. In a non-limiting example, the flowchart 600 is explained with reference to the UE 202 of FIGS. 1 – 5.

At 602, an indication from a network node regarding a network configurable prioritization criterion may be received. For example, the one or more processors (e.g., the controller/processor 228, the TX processor 224, the RX processor 226) of the UE 202 may be individually or collectively configured to receive the indication from the network node (e.g., the base station 200) regarding the network configurable prioritization criterion. The indication may provide the UE 202 with a specific configuration on how to handle potential conflicts between fallback DCI and non-fallback DCI when both are received in the same PDCCH monitoring occasion. The indication may enable the UE 202 to determine which DCI (fallback DCI or non-fallback DCI) shall be prioritized when contention occurs within a shared CORESET.

In an example, the network may provide the indication via an RRC signaling message. The RRC message may include an IE, which specifies a prioritization rule (e.g., the network configurable prioritization criterion) for handling such DCI conflicts. In an example, the RRC IE may be introduced under the following hierarchy: BWP-Downlink → BWP-DownlinkDedicated → PDCCH-Config → [IE₀, IE₁, network configurable prioritization criterion indication,IE_{N}]. The programmable aspect of the network configurable prioritization criterion may allow network nodes to dynamically adjust the behavior of the UE in response to varying network conditions and service requirements.

In an example scenario, the network configurable prioritization criterion may resolve a DCI conflict where a fallback DCI (Format 0_0/1_0) is received on the CSS and a non-fallback DCI (Format 0_1/1_1) is received on the UE-SS, both being mapped to the same CORESET and transmitted over the same CCEs with identical scrambling IDs. In one example, based on the network configurable prioritization criterion, the UE 202 may be instructed to prioritize the fallback DCI over the non-fallback DCI, ensuring that system-wide control messages such as BWP activation, system information updates, or RARs assignments are not lost. In an alternate example, based on the network configurable prioritization criterion, the UE 202 may be instructed to prioritize the non-fallback DCI over the fallback DCI, allowing the network to enforce UE-specific scheduling decisions, such as uplink grants, PUSCH transmissions, or dedicated resource allocations.

At 604, fallback DCI on a CSS and non-fallback DCI on a UE-SS may be concurrently received within a downlink control channel monitoring occasion. The CSS and the UE-SS may be associated with a same CORESET, and the fallback DCI and the non-fallback DCI may have same message size, same scrambling identifiers, and may be associated with same one or more CCEs. For example, the one or more processors (e.g., the controller/processor 228, the TX processor 224, the RX processor 226) of the UE 202 may be individually or collectively configured to concurrently receive the fallback DCI on the CSS and the non-fallback DCI on the UE-SS within a PDCCH monitoring occasion. As a result, the UE 202 may experience contention, where the UE 202 is to determine which of the two DCI formats (fallback or non-fallback) to process.

At 606, one of the fallback DCI or the non-fallback DCI may be prioritized based on the received indication. For example, one or more processors (e.g., the controller/processor 228, the TX processor 224, the RX processor 226) of the UE 202 may be individually or collectively configured to prioritize one of the fallback DCI or the non-fallback DCI based on the received indication. The indication may provide the prioritization rule that specifies whether the fallback DCI or the non-fallback DCI is to take precedence in case of a DCI conflict on overlapping CSS and UE-SS.

For example, if the fallback DCI is prioritized as per the indication, the UE 202 may prioritize the fallback DCI. Such prioritization may be useful in scenarios where system-level signaling has higher priority over UE-specific resource scheduling. On the other hand, if the non-fallback DCI is prioritized as per the indication, the UE 202 may prioritize the non-fallback DCI. Such prioritization may be beneficial in scenarios where ensuring timely transmission of user data takes precedence over general system-wide signaling.

At 608, one of the fallback DCI or the non-fallback DCI that is prioritized may be processed. For example, the one or more processors (e.g., the controller/processor 228, the TX processor 224, the RX processor 226) of the UE 202 may be individually or collectively configured to process one of the fallback DCI or the non-fallback DCI that is prioritized as described in the foregoing description of FIGS. 1 – 5.

In an example, the processing of the prioritized DCI may involve several sub-steps, for example, decoding, applying control command, interacting with Layer 2 and Layer 3 protocols, or the like. In an example, interacting with Layer 2 and Layer 3 protocols may impact, for example, Medium Access Control (MAC) layer for resource allocation, the RRC layer for state transitions, the Physical layer for signal transmission adjustments, or the like.

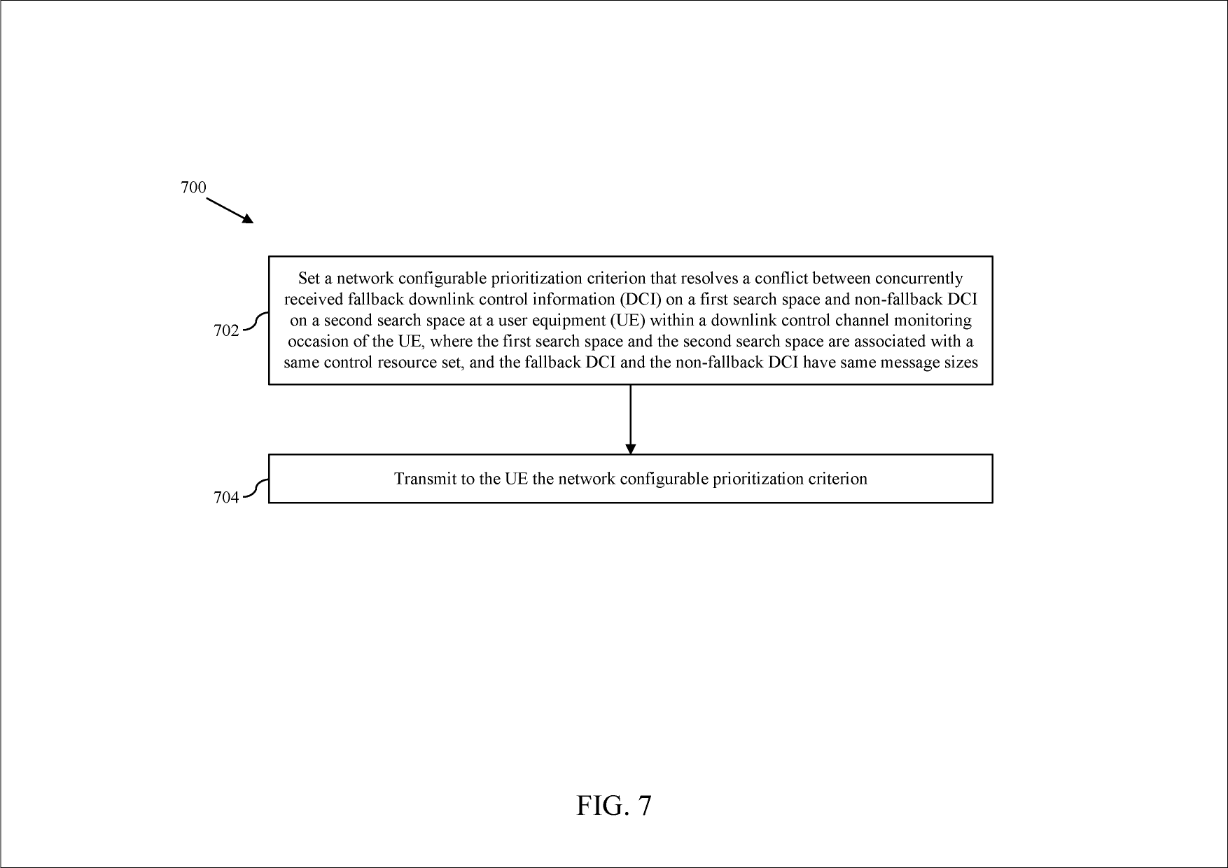

FIG. 7 is a flowchart that illustrates a method (e.g., a process) executed at a network node for managing DCI conflict at UEs in wireless communication, in accordance with an exemplary aspect of the present disclosure. In many examples, the network node can be the base station 102, the base station 200, or a different network node described in the foregoing description of FIGS. 1 – 6. Referring to FIG. 7, there is shown a flowchart 700 that illustrates exemplary operations 702 through 704 for the network node for managing DCI conflict in wireless communication. In a non-limiting example, the flowchart 700 is explained with reference to FIGS. 1 – 6.

At 702, a network configurable prioritization criterion may be set that resolves a conflict between concurrently received fallback DCI on a first search space and non-fallback DCI on a second search space at a UE within a downlink control channel monitoring occasion of the UE. The first search space and the second search space may be associated with a same CORESET, and the fallback DCI and the non-fallback DCI may have the same message sizes. For example, one or more processors (e.g., the controller/processor 214, the TX processor 210, or the RX processor 212) of the base station 200 may be individually or collectively configured to set the network configurable prioritization criterion that resolves DCI conflict, in a case where fallback DCI on a CSS and non-fallback DCI on a UE-SS, having same sizes, are concurrently received at a UE within a downlink control channel monitoring occasion of the UE.

At 704, the network configurable prioritization criterion may be transmitted to the UE. For example, the one or more processors (e.g., the controller/processor 214, the TX processor 210, or the RX processor 212) of the base station 200 may be individually or collectively configured to transmit the network-configurable prioritization criterion to the UE 202. In various aspects, the base station 200 can transmit the network configurable prioritization criterion, for example, at the time of establishment of an initial connection between the UE 202 and the base station 200, during a handover, upon receiving a system information update, or based on specific network-triggered events that involve a reassessment of prioritization rule. In an example, the base station 200 may transmit to the UE 202 an RRC message or a different higher layer signaling including one or more IEs, and an information element of the one or more IEs may include the network configurable prioritization criterion. The network configurable prioritization criterion may explicitly specify which DCI format (fallback or non-fallback) is to be prioritized in case of a DCI conflict where DCIs having the same CCEs, sizes, and scrambling IDs are concurrently received at the UE 202. Such configuration may enable flexibility, allowing the network to dynamically adjust the prioritization based on network conditions, user profiles, QoS requirements, or specific traffic demands.

Accordingly, the base station 200 may enable the UE 202 to prioritize the fallback DCI over the non-fallback DCI based on the transmission of the network configurable prioritization criterion. For example, the one or more processors (e.g., the controller/processor 214, the TX processor 210, or the RX processor 212) of the base station 200 may be individually or collectively configured to enable (e.g., configure) the UE 202 to prioritize the fallback DCI over the non-fallback DCI by transmitting the network configurable prioritization criterion.

For example, in a massive MTC (mMTC) scenario, where numerous IoT devices operate under limited bandwidth conditions, prioritizing the fallback DCI may ensure that common control messages for synchronization and resource allocation are successfully received by all UEs. On the other hand, in an ultra-reliable low-latency communication (URLLC) use case, prioritizing the non-fallback DCI may ensure that high-priority data transmissions are not delayed due to system-wide control signaling.

Some implementation examples are described in the following numbered aspects:

Aspect 1: A method for wireless communication at a user equipment (UE), the method comprising concurrently receiving fallback downlink control information (DCI) on a first search space and non-fallback DCI on a second search space within a downlink control channel monitoring occasion. The first search space and the second search space are associated with a same control resource set, and the fallback DCI and the non-fallback DCI have same message sizes. The method comprising prioritizing one of the fallback DCI or the non-fallback DCI based on at least one criterion, and processing one of the fallback DCI or the non-fallback DCI that is prioritized.

Aspect 2: The method of aspect 1, wherein the first search space corresponds to a common search space (CSS), the second search space corresponds to a UE-specific search space (UE-SS), and the CSS and the UE-SS overlap in the downlink control channel monitoring occasion.

Aspect 3: The method of any of aspects 1 through 2, wherein the fallback DCI and the non-fallback DCI have same scrambling identifiers, and the fallback DCI and the non-fallback DCI are associated with same one or more control channel elements.

Aspect 4: The method of any of aspects 1 through 3, further comprising discarding one of the fallback DCI or the non-fallback DCI that is non-prioritized.

Aspect 5: The method of any of aspects 1 through 4, further comprising prioritizing the fallback DCI over the non-fallback DCI based on the at least one criterion, and processing the fallback DCI that is prioritized.

Aspect 6: The method of aspect 5, further comprising discarding the non-fallback DCI based on the prioritization of the fallback DCI over the non-fallback DCI.

Aspect 7: The method of any of aspects 1 through 6, wherein the at least one criterion corresponds to a default prioritization criterion of the UE.

Aspect 8: The method of aspect 7, wherein the default prioritization criterion corresponds to a prioritization of first DCI having a first format on a CSS over a concurrently received second DCI having a second format on a UE-SS based on an overlap of the CSS and the UE-SS in time and frequency domains and the first DCI and the second DCI having same scrambling identifiers and same sizes.

Aspect 9: The method of aspect 8, wherein the first format corresponds to 0_0/1_0, and the second format corresponds to 0_1/1_1.

Aspect 10: The method of any of aspects 1 through 6, wherein the at least one criterion corresponds to a network configurable prioritization criterion that resolves a conflict between the fallback DCI and the non-fallback DCI that are concurrently received.

Aspect 11: The method of aspect 10, further comprising receiving an indication from a network node regarding the network configurable prioritization criterion.

Aspect 12: The method of aspect 11, further comprising receiving the indication from the network node in an information element of a radio resource control (RRC) message.

Aspect 13: The method of any of aspects 1 through 12, wherein the first search space and the second search space have one or more physical downlink control channel (PDCCH) monitoring occasions that overlap, and the downlink control channel monitoring occasion corresponds to one of the one or more PDCCH monitoring occasions.

Aspect 14: A method for wireless communication at a network node, the method comprising: setting a network configurable prioritization criterion that resolves a conflict between concurrently received fallback DCI on a first search space and non-fallback DCI on a second search space at a UE within a downlink control channel monitoring occasion of the UE. The first search space and the second search space are associated with a same control resource set, and the fallback DCI and the non-fallback DCI have same message sizes. The method comprising transmitting the network configurable prioritization criterion to the UE.

Aspect 15: The method of aspect 14, wherein the first search space corresponds to a CSS, the second search space corresponds to a UE-SS, and the CSS and the UE-SS overlap in the downlink control channel monitoring occasion.

Aspect 16: The method of any of aspects 14 through 15, wherein the fallback DCI and the non-fallback DCI have same scrambling identifiers and are associated with same one or more control channel elements.

Aspect 17: The method of any of aspects 14 through 16, further comprising transmitting an RRC message to the UE, wherein the RRC message comprises one or more information elements, and an information element of the one or more information elements comprises the network configurable prioritization criterion.

Aspect 18: The method of any of aspects 14 through 17, wherein the network configurable prioritization criterion prioritizes the fallback DCI over the non-fallback DCI.

Aspect 19: The method of any of aspects 14 through 18, further comprising enabling the UE to prioritize the fallback DCI over the non-fallback DCI based on the transmission of the network configurable prioritization criterion.

Aspect 20: A UE for wireless communication, the UE comprising one or more memories; and one or more processors coupled to the one or more memories, the one or more processors individually or collectively configured to cause the UE to perform a method of any of aspects 1 through 13.

Aspect 21: A UE for wireless communications, comprising at least one means for performing a method of any of aspects 1 through 13.

Aspect 23: A non-transitory computer-readable medium storing code for wireless communications at a UE, the code comprising instructions executable by a processor to perform a method of any of aspects 1 through 13.

Aspect 24: A network node for wireless communication, the network node comprising one or more memories; and one or more processors coupled to the one or more memories, the one or more processors individually or collectively configured to cause the UE to perform a method of any of aspects 14 through 19.

Aspect 25: A network node for wireless communications, comprising at least one means for performing a method of any of aspects 14 through 19.

Aspect 26: A non-transitory computer-readable medium storing code for wireless communications at a network node, the code comprising instructions executable by a processor to perform a method of any of aspects 14 through 19.

It should be noted that the methods described herein describe possible implementations, and that the operations and the steps may be rearranged or otherwise modified and that other implementations are possible. Further, aspects from two or more of the methods may be combined.

As used herein, the phrase 'one or more processors individually or collectively configured to’ may encompass various aspects, including but not limited to: processors that are programmed and capable of performing the function, regardless of whether execution is occurring at a given time; processors actively executing instructions to perform the function; and processors that, when triggered by an event or condition, initiate execution of the function. The scope of the phrase is not to limit the scope of the disclosure to an actively functioning device.

As used herein, the phrase ‘one or more processors individually or collectively configured to’ may encompass various aspects, including but not limited to: a single processor executing all functions; multiple processors, each performing different aspect of the function independently; multiple processors operating in coordination to execute a function collectively; or any combination thereof, where different processors may dynamically assume responsibilities based on system conditions.

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media.

The aforementioned description is provided to enable any person skilled in the art to practice the various aspects described herein. Various modifications to these aspects will be readily apparent to those skilled in the art, and the generic principles defined herein may be applied to further aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. No claim element is to be construed as a means plus function unless the element is expressly recited using the phrase “means for.” Further, unless stated otherwise, terms such as “first” and “second” are used to arbitrarily distinguish between the elements such terms describe. Thus, these terms are not necessarily intended to indicate temporal or other prioritization of such elements. The term “coupled” may refer to at least one of direct or indirect coupling that may not necessarily be by way of mechanical or any physical means. Further, a system or method that “comprises”, “has”, or “includes” one or more elements possesses those one or more elements but is not limited to possessing only those one or more elements.

What is claimed is:

1. A user equipment (UE) for wireless communication, the UE comprising:
one or more memories; and
one or more processors coupled to the one or more memories, the one or more processors individually or collectively configured to cause the UE to:
concurrently receive fallback downlink control information (DCI) on a first search space and non-fallback DCI on a second search space within a downlink control channel monitoring occasion, wherein
the first search space and the second search space are associated with a same control resource set, and
the fallback DCI and the non-fallback DCI have same message sizes;
prioritize one of the fallback DCI or the non-fallback DCI based on at least one criterion; and
process one of the fallback DCI or the non-fallback DCI that is prioritized.

2. The UE of claim 1, wherein
the first search space corresponds to a common search space (CSS),
the second search space corresponds to a UE-specific search space (UE-SS), and
the CSS and the UE-SS overlap in the downlink control channel monitoring occasion.

3. The UE of claim 2, wherein
the fallback DCI and the non-fallback DCI have same scrambling identifiers, and
the fallback DCI and the non-fallback DCI are associated with same one or more control channel elements.

4. The UE of claim 1, wherein the one or more processors individually or collectively are further configured to cause the UE to discard one of the fallback DCI or the non-fallback DCI that is non-prioritized.

5. The UE of claim 1, wherein the one or more processors individually or collectively are further configured to:
prioritize the fallback DCI over the non-fallback DCI based on the at least one criterion; and
process the fallback DCI that is prioritized.

6. The UE of claim 5, wherein based on the prioritization of the fallback DCI over the non-fallback DCI, the one or more processors individually or collectively are further configured to discard the non-fallback DCI.

7. The UE of claim 1, wherein the at least one criterion corresponds to a default prioritization criterion of the UE.

8. The UE of claim 7, wherein the default prioritization criterion corresponds to a prioritization of first DCI having a first format on a common search space (CSS) over a concurrently received second DCI having a second format on a UE-specific search space (UE-SS) based on an overlap of the CSS and the UE-SS in time and frequency domains and the first DCI and the second DCI having same scrambling identifiers and same sizes.

9. The UE of claim 8, wherein
the first format corresponds to 0_0/1_0, and
the second format corresponds to 0_1/1_1.

10. The UE of claim 1, wherein the at least one criterion corresponds to a network configurable prioritization criterion that resolves a conflict between the fallback DCI and the non-fallback DCI that are concurrently received.

11. The UE of claim 10, wherein the one or more processors individually or collectively are further configured to receive an indication from a network node regarding the network configurable prioritization criterion.

12. The UE of claim 11, wherein the one or more processors individually or collectively are further configured to receive the indication from the network node in an information element of a radio resource control (RRC) message.

13. The UE of claim 1, wherein the first search space and the second search space have one or more physical downlink control channel (PDCCH) monitoring occasions that overlap, and the downlink control channel monitoring occasion corresponds to one of the one or more PDCCH monitoring occasions.

14. A network node for wireless communication, the network node comprising:
one or more memories; and
one or more processors coupled to the one or more memories, the one or more processors individually or collectively configured to cause the network node to:
set a network configurable prioritization criterion that resolves a conflict between concurrently received fallback downlink control information (DCI) on a first search space and non-fallback DCI on a second search space at a user equipment (UE) within a downlink control channel monitoring occasion of the UE, wherein
the first search space and the second search space are associated with a same control resource set, and
the fallback DCI and the non-fallback DCI have same message sizes; and
transmit the network configurable prioritization criterion to the UE.

15. The network node of claim 14, wherein
the first search space corresponds to a common search space (CSS),
the second search space corresponds to a UE-specific search space (UE-SS), and
the CSS and the UE-SS overlap in the downlink control channel monitoring occasion.

16. The network node of claim 15, wherein the fallback DCI and the non-fallback DCI have same scrambling identifiers and are associated with same one or more control channel elements.

17. The network node of claim 16, wherein the network configurable prioritization criterion prioritizes the fallback DCI over the non-fallback DCI.

18. The network node of claim 14, wherein the one or more processors individually or collectively are further configured to transmit a radio resource control (RRC) message to the UE, wherein
the RRC message comprises one or more information elements, and
an information element of the one or more information elements comprises the network configurable prioritization criterion.

19. A method for wireless communication performed by a user equipment (UE), the method comprising:
concurrently receiving fallback downlink control information (DCI) on a first search space and non-fallback DCI on a second search space within a downlink control channel monitoring occasion, wherein
the first search space and the second search space are associated with a same control resource set, and
the fallback DCI and the non-fallback DCI have same message sizes;
prioritizing one of the fallback DCI or the non-fallback DCI based on at least one criterion; and
processing one of the fallback DCI or the non-fallback DCI that is prioritized.

20. The method of claim 19, further comprising discarding one of the fallback DCI or the non-fallback DCI that is non-prioritized.
